(19) United States
(12) Patent Application Publication
(10) Pub. No.: US 2011/0316259 A1
(43) Pub. Date: Dec. 29, 2011

(54) AIRBAG

(76) Inventor: Philipp Ritter, Alfdorf (DE)

(21) Appl. No.: 13/147,831

(22) PCT Filed: Feb. 17, 2010
(86) PCT No.: PCT/EP10/00977

§ 371 Date: Aug. 24, 2011

(30) Foreign Application Priority Data
Feb. 20, 2009 (DE) 10-2009-009-905.0

(51) Int. Cl. B60R 21/16

(52) U.S. Cl. 280/728.1

(57) ABSTRACT

An airbag has a fabric including a polyester yarn having an elongation at break of approximately 20 to 30%, especially approximately 24 to 25%, and having a shrinkage that is less than approximately 1%, especially less than 0.5%.

### RELATED APPLICATIONS

This application corresponds to PCT/EP2009/008422, filed Nov. 26, 2009, which claims the benefit of German Application No. 10 2008 060 305.8, filed Dec. 3, 2008, the subject matter of which is incorporated herein by reference in their entirety.

### BACKGROUND OF THE INVENTION

The invention relates to an airbag.

At present airbags are preferably made of a polyamide fabric, wherein as yarn for the fabric frequently PA66 (nylon) is made use of.

Efforts are made to replace the nylon yarn with a polyester yarn, because the manufacture of the latter is less complicated and less expensive, as described in U.S. Pat. No. 7,375,042, for instance.

### SUMMARY OF THE INVENTION

It is the object of the invention to provide an airbag which includes a fabric with a polyester yarn while at the same time maintaining the positive characteristics of an airbag having a fabric consisting of nylon.

This is achieved by an airbag having a fabric which includes a polyester yarn the elongation at break of which is approximately 20% to 30%, especially approx. 24% to 25%, and the shrinkage of which is less than approximately 1%, especially less than 0.5%. Exactly the characteristics of the yarn largely determine the characteristics of the fabric. In order to be suited for use in an airbag, the yarn has to have, while exhibiting sufficient strength or breaking strength, an as high elongation as possible and simultaneously has to excel by an as low shrinkage as possible in heat and/or moisture. It is ensured with said parameters that the technical requirements made to an airbag can be met.

It is possible to manufacture the fabric of the airbag completely of such yarn.

The viscosity of a yarn in general is inversely proportional to the elongation at break thereof so that yarns having a high viscosity have less elongation and vice versa. The viscosity of the polyester yarn used in the invention preferably ranges between 65 cN/tex and 75 cN/tex, especially approximately between 70 cN/tex and 71 cN/tex.

The breaking strength of the polyester yarn preferably amounts to 30% to 40%, especially to approximately 33% to 34%.

In the case of airbags of polyamide yarn the cover factor of the fabric advantageously ranges approximately between 1800 and 2000. The cover factor is calculated from the thread size d in deniers and the thread density wc and fc of the warps and wefts per inch (cover factor=√d*wc+√d*fc).

Polyester has a higher specific density (1.38 compared to 1.14) and thus a lower volume than nylon. In order to obtain an equivalent cover factor using a polyester yarn, the higher specific density has to be taken into account and compensated for by a larger thread size. A fabric made of a nylon thread having a thread size of 347 deniers in a composite fabric of 50 respective warps and wefts per inch has a cover factor of 1863, for instance. In order to obtain a corresponding fabric with a polyester yarn, the thread size must be adapted in accordance with the different specific densities so that in the case of the invention preferably a thread size of 420 deniers is resulting for a polyester yarn which as to volume is equivalent to a nylon yarn of 347 deniers.

Preferably, the thread size of the polyester yarn approximately is between 400 and 450 deniers.

The polyester yarn preferably had an ITC factor of more than approximately 1%, with ITC being abbreviated for Instantaneous Thermal Creep. This was measured at 100° C. The ITC value was determined analogously to the method given in U.S. Pat. No. 7,375,042.

### BRIEF DESCRIPTION OF THE DRAWINGS

Further features and advantages of the invention are resulting from the following description of an embodiment in combination with the enclosed drawings, in which

FIG. 1 schematically shows an airbag according to the invention;

FIG. 2 shows a diagram illustrating the adhesion of a coating on different fabrics, including a fabric of an airbag according to the invention; and

FIG. 3 shows pressure curves for two airbags according to the invention.

### DESCRIPTION OF EXEMPLARY EMBODIMENTS

FIG. 1 shows an airbag 10 in the form of a conventional curtain-shaped side airbag. But the airbag 10 could as well be of any other type, such as a driver-side or passenger-side airbag, a side airbag deploying from the backrest or a knee airbag.

The airbag 10 consists of a fabric made of polyester yarn having a filament figure of 96, breaking strength of 33.5 N, viscosity of 70.6 cN/tex, elongation at break of 24.4% and shrinkage of 0.3%. The shrinkage was measured according to the ASTM D 4974 method in which a relaxed thread sample is subjected to dry heat at a predetermined tension for a predetermined period of time. In said example the load is 0.05 cN/dtex at a temperature of 177° C. for a period of time of 10 minutes. The mean value established for the magnitude of the ITC was 1.5% (having a standard deviation of 21%).

From this yarn a fabric having a yarn density of 19.5×19.5 warps and wefts per cm was manufactured. Said fabric exhibited a breaking strength of 3030 N in the warp direction and 3186 N in the weft direction while having an elongation at break of 31% in both directions. The total weight of the fabric was 195 g/m². Further data for said fabric can be inferred from table 1 in which also a conventional airbag fabric made of 470 dtex PA66 yarn is listed for the purpose of comparison.

TABLE 1

| | | | | 470dtex |
|---|---|---|---|---|
| TEST | UNIT | DIRECTION | 470dtexPA66 | PES |
| TOTAL WEIGHT | g/m² | | 172 | 195 |
| CONSTRUC- | warp | warp | 171 | 196 |
| TIONAL | threads/dm | | | |
| DENSITY | | | | |
| | weft | weft | 173 | 199 |
| | threads/dm | | | |
| THICKNESS | mm | | 0.30 | 0.24 |
| VISCOSITY | N | warp | 2978 | 3030 |
| | | Weft | 2943 | 3186 |
| ELONGATION | % | warp | 20.0 | 31.0 |
| | | weft | 25.0 | 31.0 |
| INFLAM - | mm/min | warp | 1 | 2 |
| MABILITY | | weft | 1 | 2 |
| COMB DRAWING | N | warp | 164 | 373 |
| FORCE | | weft | 175 | 342 |
| RIGIDITY | N | warp | 3.8 | 5.1 |
| | | weft | 3.8 | 5.4 |
| TEAR | N | warp | 194 | 135 |
| PROPAGATION | | weft | 213 | 142 |
| FORCE | | | | |

The fabric was fabricated by the water jet method and was subsequently provided with a silicone coating of 25 g/m² (Bluestar TCS 7534). The fabric was used right from the loom without any further pre-treatments. Further data concerning this text compared to the equally coated conventional fabric of 470 dtex PA66 yarn are illustrated in Table 2.

TABLE 2

| | | | | | | CSS | Coating |
|---|---|---|---|---|---|---|---|
| | | | | | | 470dtex | 470dtex |
| TEST | ISO/ASTM | Unit | Direction | Min | Max | PA66 | PES |
| TOTAL WEIGHT | ISO3801 | g/m² | NA | 195 | 225 | 210 | 212 |
| STRUCTURAL | ISO 7211-2 | per dm | warp | 172 | 188 | 178 | 196 |
| DENSITY | | per dm | weft | 167 | 183 | 178 | 190 |
| THICKNESS | ISO 5084 | mm | NA | 0.25 | 0.35 | 0.28 | 0.24 |
| MAXIMUM | ASTMD5035 | N | warp | 2500 | na | 3363 | 3082 |
| TENSILE | | N | weft | 2500 | na | 3297 | 3174 |
| FORCE (50 MM | | | | | | | |
| RAVEL STRIP | | | | | | | |
| TENSILE) | | | | | | | |
| ELONGATION | ASTMD5035 | % | warp | 25 | 45 | 31.3 | 30.1 |
| | | % | weft | 25 | 45 | 31.0 | 29.7 |
| INFLAMMABILITY | ISO 3795 | mm/min | warp | na | 100 | 2 | 2 |
| | | mm/min | weft | ra | 100 | 2 | 2 |
| COMB | ASTMD6479 | N | warp | 250 | | 366 | 513 |
| DRAWING | | N | weft | 250 | | 369 | 430 |
| FORCE | | | | | | | |
| FLEXURAL | ASTMD4032 | N | NA | | 6.0 | 5.7 | 8.1 |
| STRENGTH | | | | | | | |
| TEAR | ISO 13937-2 | N | warp | 175 | | 285 | 289 |
| PROPAGATION | | N | weft | 175 | | 276 | 263 |
| FORCE | | | | | | | |
| FRICTION | ISO 8295 | N/M | warp | | 0.4 | 0.24 | 0.23 |
| COEFFICIENT - | | N/N | weft | | 0.4 | 0.20 | 0.17 |
| STATIC | | | | | | | |
| ABRASION | ISO 5981 | Strokes | warp | 500 | | 2000 | 2000 |
| RESISTANCE | | Strokes | weft | 500 | | 2000 | 2000 |

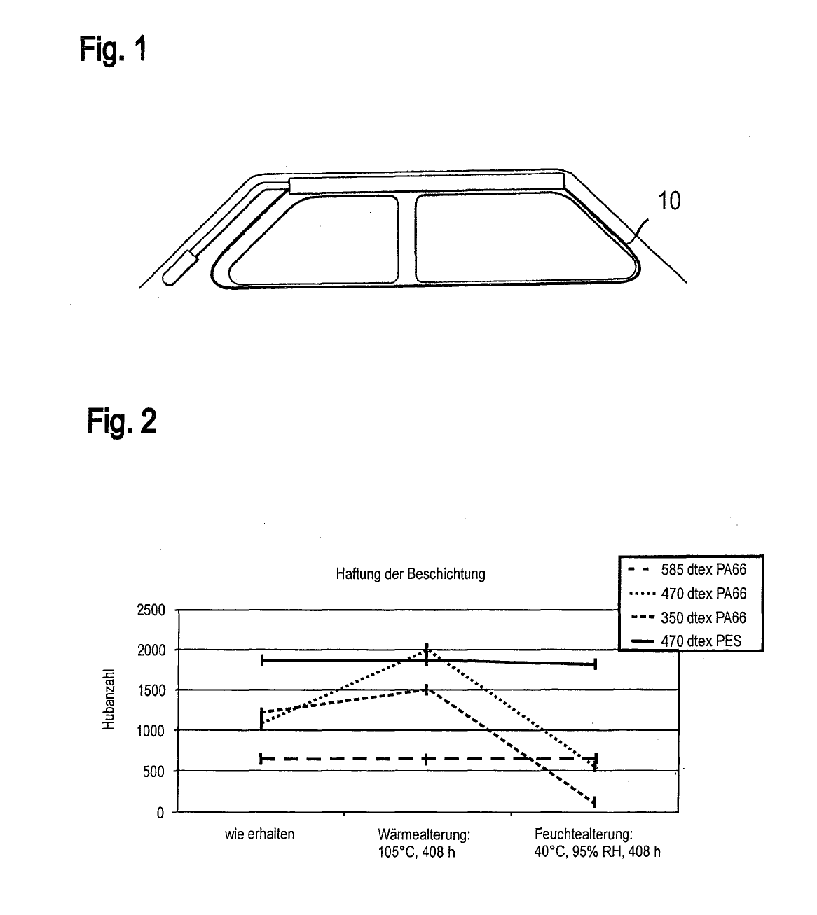

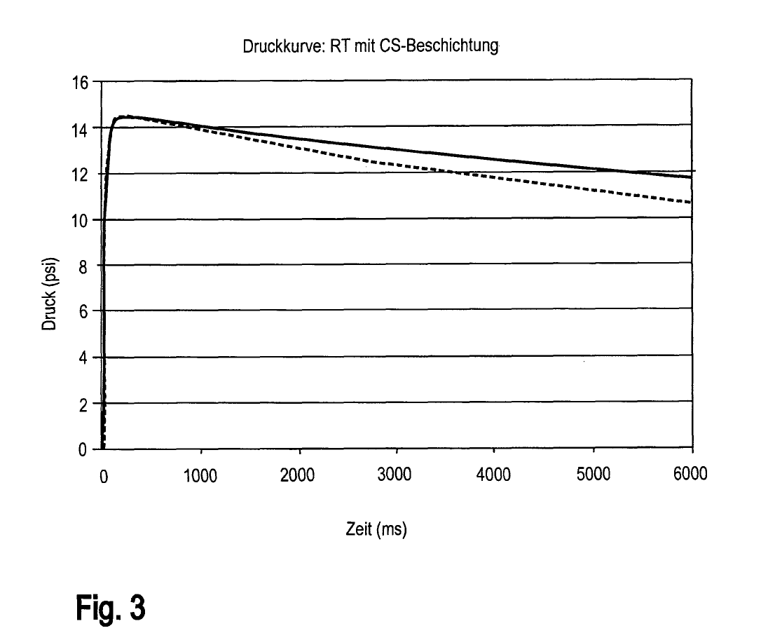

For the airbag fabric of polyester yarn a constantly high adhesive force for the coating is resulting both directly after application of the coating and after heat aging for 408 hours at 105° C. or moisture aging for 408 hours at 40° C. and a relative humidity of 95% (cf. FIG. 2).

Two side airbags made of said polyester yarn and woven in one piece which were provided with a PVC/polyurethane coating of 75 g/m², with an initial filling pressure of more than 965 hPa (14 psi) after 5 s still exhibited an internal pressure of more than 689 hPa (10 psi). In this case a fabric density of 22 warp threads to 19.5 weft threads per cm was used for each layer. In FIG. 2 a filling test is illustrated with two airbags according to the invention manufactured with identical parameters. In general, a pressure of 50% of the maximum pressure after 5 s is considered to be sufficient for a roll-over protection.

It is also an advantage of the low shrinkage rate of the yarn that the width of the fabric panel can be better exploited, which has a positive effect on the arrangement of the airbag cuts. For instance, with the present water-jet weaving technology a maximum reed width of 230 cm can be obtained. When using a typical nylon yarn a maximum usable fabric width of approximately 200 cm is resulting therefrom. With the polyester yarn having low shrinkage used for this purpose a usable width of 210 cm can be expected with the same machine. A similar result is obtained when using a jacquard weaving machine for airbags woven in one piece. Said weaving machines usually function according to the Rapier method or by air-jets. Typically they have a maximum reed width of 280 cm, which results in a maximum usable fabric width of approximately 245 cm when making use of a conventional nylon thread. Thus a maximum airbag height of approximately 600 mm is permitted with a cut arrangement in four rows. The polyester yarn employed here, however, allows obtaining an airbag height of 625 mm. When arranging the cuts in five rows respective airbag heights of 500 mm can be obtained.

When making use of the afore described advantages, in the case of coated fabrics for airbags high-shrinking yarns can be dispensed with, because the gas permeability is reduced or prevented by the coating. But also with uncoated fabrics an impermeability to gas sufficient for a variety of applications can be reached by such polyester yarn.

1. An airbag comprising a fabric including a polyester yarn having an elongation at break of approximately 20 to 30%, and having a shrinkage that is less than approximately 1%.

2. The airbag according to claim 1, wherein the fabric of the airbag consists of said polyester yarn.

3. The airbag according to claim 1, wherein the viscosity of the polyester yarn ranges approximately between 65 and 75 cN/tex.

4. The airbag according to claim 1, wherein the breaking strength of the polyester yarn is approximately 30 to 40%.

5. The airbag according to claim 1, wherein the thread size of the polyester yarn approximately ranges between 400 and 500 deniers.

6. The airbag according to claim 1, wherein the ITC factor of the polyester yarn is more than 1%.

7. The airbag according to claim 1, wherein the elongation at break is approximately 24 to 25%.

8. The airbag according to claim 1, wherein the shrinkage is less than 0.5%.

9. The airbag according to claim 1, wherein the viscosity of the polyester yarn ranges between 70 and 71 cN/tex.

10. The airbag according to claim 1, wherein the breaking strength of the polyester yarn is approximately 33 to 34%.
